(19) United States
(12) Patent Application Publication
(10) Pub. No.: US 2014/0269765 A1
(43) Pub. Date: Sep. 18, 2014

(54) Broadcast Network

(71) Applicant: Cognitive Electronics, Inc., Boston, MA (US)

(72) Inventor: Andrew C. FELCH, Palo Alto, CA (US)

(73) Assignee: COGNITIVE ELECTRONICS, INC., Boston, MA (US)

(21) Appl. No.: 14/212,141

(22) Filed: Mar. 14, 2014

Related U.S. Application Data
(60) Provisional application No. 61/791,004, filed on Mar. 15, 2013.

(51) Int. Cl. H04J 3/06

(52) U.S. Cl. CPC H04J 3/0638
USPC 370/469; 370/507

(57) ABSTRACT

A system and associated methods are disclosed for routing communications amongst computing units in a distributed computing system. In a preferred embodiment, processors engaged in a distributed computing task transmit results of portions of the computing task via a tree of network switches. Data transmissions comprising computational results from the processors are aggregated and sent to other processors via a broadcast medium. Processors receive information regarding when they should receive data from the broadcast medium and activate receivers accordingly. Results from other processors are then used in computation of further results.

### CROSS-REFERENCE TO RELATED APPLICATION

This application claims the benefit of U.S. Provisional Application No. 61/791,004, filed Mar. 15, 2013.

### FIELD OF THE INVENTION

This invention relates generally to communication among computing elements in a distributed computing system, and particularly, broadcast communication between processors allocated to a distributed computing task.

### BACKGROUND OF THE INVENTION

While the capabilities of computers have increased rapidly over the past decades, there are still many tasks for which the human brain is better suited. By developing computers and networks that utilize communication characteristics of the brain, the performance of brain-inspired software algorithms might be improved.

FIG. 1 is a simplified schematic of a circuit modeling certain aspects of the brain. In this model, the Thalamocortical loop is a recurrent circuit involving the Neocortex brain structure 100, whose Pyramidal Neurons P1-PN (101) send axonal outputs 102 to the dendritic inputs 152 & 153 of Thalamus 160 brain structure. The axons 102 connect to the dendrites 152 & 153 at synapses 132 & 133, respectively. The Thalamus 160 is divided into two areas called TCore (short for “Thalamus Core”, which is a term not used herein in order to avoid confusion with the term “Core” which is used herein) 110 and TMatrix (short for “Thalamus Matrix”) 120. The TCore synapses 132 are arrayed in a regular pattern whereas the TMatrix synapses 133 are semi-random.

The TCore dendrites 152 convey the input signals received at the synapses 132 to the TCore neurons 136. The TCore neurons send their outputs onto the TCore Return Path 150 where they connect in a regular arrangement to the dendrites 170 of the Pyramidal neurons 101 via synapses 130. The result of the regular arrangement is that Pyramidal neurons 101 that are physically close together in Neocortex 100 and send action potentials (active signals) result in action potential input via the TCore Return Path that are received by the original sending neurons 101, or neurons nearby them.

The regularity of the synaptic connections 130, 132 along the Thalamocortical TCore loop, including 150, 110, lies in contrast to the semi-random nature of the synaptic connections 131, 133 along the Thalamocortical TMatrix loop (including 140 and 120).

The result is that a signal sent by one pyramidal neuron 101 causes a more spread-out set of neurons 137 in the TMatrix 120 to receive dendritic input 153 from their synapses 133. Upon receiving signals from Pyramidal neurons 101, the spread-out set of neurons 137 of TMatrix 120 are more likely to send signals themselves. These signals are conveyed via the TMatrix Return path 140. There, additional spreading-out occurs so that activity from one pyramidal neuron 101 increases the likelihood that a set of very spread out pyramidal neurons 101, potentially quite distant from the originally signaling neuron 101, receive input via the TMatrix Return Path 140.

Three additional aspects of the brain model impact its communications patterns. The first is the relatively slow nature of the synaptic signal conveyance, which typically adds 1 millisecond or more to the latency of the signal transfer. This amount of latency is high, preferably very high, relative to some of the pathways in computer microprocessors, which are now typically measured in picoseconds. Second, synapses 130, 131, 132, 133 are not instantaneously created, but grow over the course of minutes, hour, or even days. It may also take minutes or longer for an existing synapse to disappear. It is possible, therefore, that the set of pyramidal neurons 101 that receive dendritic input 170 from a given neuron's axon (140, 150) does not change frequently. Finally, there are a large number of neurons involved in the TMatrix Thalamocortical loop and each axon can send its signals to a different subset of receiving neurons.

While communications in the brain model comprises conveyance of action potentials, computing applications require transmission of more complex and structured data. A variety of message formats may be used for these communications, depending upon the type of message passing being used.

FIG. 2 depicts aspects of exemplary messages (201-206) sent via Unicast Message Passing 200. Unicast Message Passing 200 has the characteristic that each message (201-206) is generally sent to exactly one recipient (210-215, respectively). For example, Message 1 (201) sends Data 1 (220) to Recipient R1 (210). Message 2 (202) sends the same data, Data 1 (220), to Recipient R2 (211). Message R (202) sends the same data, Data 1 (220), to Recipient RF (212).

To send Data 2 (221) to R Recipients S1, S2, . . . SG (213, 214, 215), R messages (204, 205 . . . 206) are sent. For example, Message R+1 (204) sends Data 2 (221) to Recipient S1 (210). Message R+1 (205) sends the same data, Data 2 (221), to Recipient S2 (214). Message 2*R (206) sends the same data, Data 2 (221), to Recipient SG (215). Note that while here G=R, a given message may be sent to different numbers of recipients depending on the set of desired recipients.

The Unicast Message Passing 200 method is inefficient for sending a single message to multiple recipients. Standard non-Unicast solutions (FIGS. 3, 4), however, do not solve the problem well in the case of TMatrix Thalamocortical loop-like communications.

FIG. 3 depicts aspects of exemplary messages sent with Multicast Message Passing with Recipient List Embedded in Message (300). This style of message passing allows multiple recipients per message, such as R1, R2, . . . RF (301, 302, 303) for Message 1 (340), S1, S2, . . . SG (304, 305, 306) for Message 2 (350), and T1, T2, . . . TH (307, 308, 309) for Message M (360). Each of these messages (340, 350, 360) sends a different piece of data (320, 321, 322) to the set of recipients designated in that specific message.

A problem with Multicast Message Passing with Recipient List Embedded in Message (300) is that the length of the message still scales with the number of recipients. For example, a message destined for 100 recipients requires 100 recipient entries to be stored in the message.

One method to reduce message length in such cases is to remove from the recipient list those recipients who are irrelevant to the particular networking switch that receives the message. This solution, however, complicates the implementation of the routing switches and is only a partial relief from the overhead of carrying the recipient list within the message.

FIG. 4 depicts exemplary messages of a system using Multicast Message Passing with subscriber List Embedded in Network Switches (400). This message passing system 400 retains the benefit of the system depicted in FIG. 3 of sending one message (440, 450, 460) per piece of data (420, 421, 422 respectively). However, it has the added benefit over the system of FIG. 3 in that the list of recipients (301-303, 304-306, 307-309) does not have to be sent with each message 440, 450, 460. Instead, the system of FIG. 4 (400) includes in each message (440, 450, 460) the relevant Subscription Index (401, 402, 403, respectively). The list of recipients for each Subscription Index is stored within the network switches. The network switches then utilize the lists of subscribers to determine how to forward the message.

The system of FIG. 4 is a standard method for solving Multicast Message Passing using custom network hardware. However, this method has significant weaknesses with respect to the communication requirements and patterns typical of the TMatrix Thalamocortical loop, as illustrated by FIG. 5.

FIG. 5 depicts an exemplary network implementing the Multicast Message Passing with subscriber List Embedded in Network Switches 400. It further depicts an example multicast Messages (510) delivery via network switches (520, 530, 550) and bolded connections (540, 541, 542, 543, 575) to the correct set of receiving processors (570). For simplicity, the figure depicts an example wherein each of the Subscription Lists (521, 531, 532, 555, 556, 557, 558) holds entries for R different subscription lists. For implementation of a computer simulation of the TMatrix thalamocortical loop, where each “neuron” has a different subscriber list, R is equal to the number of “neurons.” For such an implementation, where multicast is leveraged to simulate the one-to-many communication pattern of axons, a very large subscriber list is required and the value of R is prohibitively large. Even if a simulation were performed at the scale of a brain of a small mammal, it would still comprise hundreds of millions of lists. Modeling the brain simulation at a higher level of granularity than the neuron only partially solves the problem (since there are still hundreds of thousands of groups of 1,000 neurons), and a key enabling aspect needed by the intelligent algorithm the brain implements may be lost.

FIG. 5 further depicts that many processors 560 do not receive the signal. This is indicated by non-bolded connection 580. Although three out of four of the Tier B Switches 550 have only a single processor 570 receiving the signal, and the other example switch sends the signal to two processors 570, every Tier B Network Switch 550 must receive the signal. Thus, in this example, the randomness of the subset of recipients resulted in very little pruning within the network switches. Therefore, the Subscription Lists 521, 531, 532 above the lowest Tier (Tier B, 550) are not enabling the network to be any more efficient than a broadcast network.

What is needed is a system that provides some of the communications advantages of the of the brain, but with methods of routing and transmitting messages within the system that work within the practical limitations of computing hardware.

### SUMMARY OF THE INVENTION

A system and associated methods are disclosed for routing communications amongst computing units in a distributed computing system. In a preferred embodiment, processors engaged in a distributed computing task transmit results of portions of the computing task via a tree of network switches. Data transmissions comprising computational results from the processors are aggregated and sent to other processors via a broadcast medium. Processors receive information regarding when they should receive data from the broadcast medium and activate receivers accordingly. Results from other processors are then used in computation of further results.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown.

FIG. 1 is an schematic of a circuit exhibiting certain aspects of the brain;

FIG. 2 depicts aspects of exemplary messages sent via Unicast Message Passing;

FIG. 3 depicts aspects of exemplary messages sent with Multicast Message Passing with Recipient List Embedded in Message;

FIG. 4 depicts exemplary messages of a system using Multicast Message Passing with subscriber List Embedded in Network Switches;

FIG. 5 depicts an exemplary network implementing the Multicast Message Passing with subscriber List Embedded in Network Switches;

FIG. 6 depicts a preferred embodiment of a system using a message passing architecture;

FIG. 7 depicts a power saving mechanism for use with the network architecture of FIG. 6;

FIG. 8 is a simplified schematic of an embodiment of an additional power saving mechanism that can be built into the network architecture of FIG. 6;

FIG. 9 is a flow chart of an exemplary process for a Bulk Synchronous programming paradigm for use with the network architecture of FIG. 6; and

FIG. 10 is a flow chart of an exemplary process performed by the Message Aggregator during execution of a Bulk Synchronous Program in a system using the architecture of FIG. 6.

### DETAILED DESCRIPTION OF THE INVENTION

FIG. 6 depicts a preferred embodiment of a communications architecture for use in a distributed computing system. In the illustrated embodiment, a number of Processors 601 engage in communications over a network. Processors 601 may, for instance, each be part of a single- or multi-processor general purpose computing platform or components on single- or multi-processor boards in a chassis housing multiple boards. In a preferred embodiment, the processors may utilize the architecture or design described in co-pending U.S. application Ser. No. 14/199,321 filed Mar. 6, 2014, incorporated herein by reference. In a preferred embodiment, the processors are used to perform distributed computing tasks and communicate with each other as a part of the performance of those tasks.

In a preferred embodiment, the network is organized as a fat-tree topology. In this embodiment, a number of lowest-level switches, here termed “Tier B Switch” 603, connect to the Processors 601 via connections 602. The Tier B Switches 603 preferably connect to Tier 1 Switches 605 via connections 604 that are higher bandwidth per link than connections at the lower level 602. In this way, it is possible for a larger number of Processors 601, such as four processors, to send information via four 602 links to two Tier B switches 603, which send the information on to one Tier 1 Switch 605 via two links 604.

It is to be understood that the number of switches in each tier and the number of tiers may vary depending, for instance, on the number of processors in the system and the bandwidth capabilities and requirements. Furthermore, it is to be understood that the number of processors connected to each switch and the number of switches at each tier connected to each switch at the next-higher tier may also vary.

The selection of how much bandwidth the connections 604 should support is preferably determined by the amount of information the processors 601 need to send to a set of recipients. For example, in a situation where connections 602 support 100 Megabytes/second (MB/s) and need to send 60 MB/s of data via a Multicast-like message to a number of recipients, and assuming 5 MB/s overhead, the links 604 from Tier B switches 603 to Tier 1 switches 605 should support the number of links being aggregated, in this case, 2, times the bandwidth that needs to be supported, which is 2*65 MB/s=130 MB/s in this example. Links 606 from Tier 1 Switches 605 to the Tier 0 Switch 607 should also support the demand for bandwidth from the aggregated links 604. In this example, the bandwidth should therefore support 2*130 MB/s=260 MB/s. Finally, the link 608 from the Tier 0 switch 607 to the Message Aggregator 610 should support the aggregating bandwidth requirements, which are 2*260 MB/s in this case, which is equal to 520 MB/s. The Message Aggregator 610 sends messages received via its input link 608 onto a broadcast line 620 which is transmitted to all of the Processors.

It is noteworthy that the switches 603, 605, 607 preferably implement a point-to-point network so that regular messages can be passed between processors. Processors may update their recipient tables, and perform traditional unicast message passing, through such conventional means provided by these point-to-point switches. The higher tiers of the network switches (e.g., 607) may be implemented with multiple switches, such as in a butterfly fat-tree network, and the Message Aggregator 610 may be implemented to accommodate multiple top-tier switches, or multiple message aggregators 610 may coordinate to transmit over the broadcast data 620.

One issue that may arise in a standard architecture implementing the design of FIG. 6 is that the power consumption required by the Processors to decode all of the broadcast messages is prohibitive. The system may therefore leverage two mechanisms to improve power efficiency, which will be shown in FIGS. 7 and 8.

FIG. 7 depicts a power saving mechanism for use with the network architecture. Here, the Message aggregator 610 sends Broadcast Data 620 to the Receiver 740 component of the Processor 601. Rather than receiving all data that is broadcast to it, the Receiver is preferably activated at key points in time, at which point the Activator 725 sends an “activate” signal 735. The signal 735 causes the Receiver to “turn on” momentarily in order to receive data on a specific channel of the Broadcast Data 620. In a preferred embodiment, upon receiving the activate signal 735, the receiver is configured to receive data using a certain wavelength of light in the case that the Broadcast Data 620 and Receiver 740 use Dense Wavelength Division Multiplexed (DWDM).

The activation signal 735 is preferably sent at a specific time, thereby taking advantage of Time-Division-Multiplexing (TDM), which divides each physical broadcast channel into multiple logical channels divided in time. The Activator 725 is preferably synchronized with the arrival of the Broadcast Data 620 via input 720 from Time unit 715. The Time unit 715 is preferably synchronized via input 710 received of Time Synchronization Signal 705, transmitted as Timing signal output 700 from the Message Aggregator 610. The Time Unit 715 may also receive some time stamp information in the Broadcast Data 620 stream in order to determine the differences in delay between the time indicated by the Time Synchronization Signal 705 and the Broadcast Data 620.

The Activator requests information regarding the next channel to be received 755 by requesting the entry from the List of channels to Receive 730 at the Index 760. The List of channels to Receive 730 may be stored based upon absolute time or relative time. In absolute time, entries regarding receiving data, for instance, on physical channel 0 at 20 microseconds, physical channel 7 at 50 microseconds, and channel 3 at 60 microseconds might be stored as the list of tuples: (0, 20), (7, 50), (3, 60). In relative time format, the List of channels to receive would be stored in time as the difference between the time at which the tuple indicates the data is to be received and the time of the previous entry. In relative time, therefore, the List of channels to Receive 100 might be stored as the list of tuples: (0, 20), (7, 30), (3, 10).

A hybrid method uses periodic key frames, so that, for instance, entries 0, 10, 20, etc. would be stored as absolute time indications, and entries 1-9, 11-19, 21-29 etc. would be stored as relative values. By storing more of the time values as relative values, the storage requirements are reduced for each entry, as fewer bits are required to store smaller values.

The Activator 725 requests the Next channel entry 755 by indicating the Index 760 of the entry. The Activator 725 then uses the input 720 it receives from the Time unit 715 to determine the moment at which the Receiver 740 should be activated, and the length of time for which it should be activated on that channel.

In one preferred embodiment, the Activator 725 fetches the next channel from the List of channels to Receive 730 so that it knows the next time the Receiver 740 should be activated via link 735 for each physical channel that is available. For example, if DWDM is used and 40 optical channels are available, then the activator 725 preferably activates 40 units internal to the Receiver 740 over link 735 using 40 different units internal to the Activator 725, one for each channel, each waiting until the next moment at which the corresponding physical channel is to be received.

Next, channels 755 requested from the List of channels to Receive 730 also preferably have a “List of recipients” 765 associated with the data that will be received on each channel. The “List of recipients” 765 is sent to the Receiver-to-NOC adapter 750, which, in one preferred embodiment, converts the Received Broadcast data 745 to unicast messages. Although Unicast Message Passing is less efficient for carrying out logical multicast message passing, the present network architecture may be designed with an increased or decreased number of cores per processor (i.e. increasing or decreasing the granularity at which the conversion from broadcast to unicast occurs) in order to create Lists of recipients that are on average small and/or close to 1 recipient per received channel. On the other hand, the high performance at which unicast packets can be transmitted within a chip can result in low total cost to transmit the packets in unicast over the short distances or an on-chip network.

In another embodiment, all of the Received Broadcast data is transmitted to the Network-on-chip 775 where it is broadcast to all cores, possibly with flag values in each packet notifying a core as to whether it is supposed to receive the packet. The Network-on-chip 775 may therefore implement a Multicast Message Passing with Recipient List Embedded in Message 300. In fact, the preferred embodiment may implement the list of recipients as simple bit flags so that the index of the bit indicates which core may be the recipient, and the value indicates “Is Recipient” (e.g. bit value “1”) or “Not Recipient” (e.g. bit value “0”). For 32 cores 780, the recipient list therefore is preferably only 32 bits, which is very efficient. Each core 780 may perform its own filtering etc., in order for the proper threads running on that core to receive the message. The Reciever-to-NOC adapter 750 would be responsible in this embodiment for merging the Received Broadcast data 620 with the List of Recipients for a valid message packet in the format of Multicast Message Passing with Recipient List Embedded in Message 300.

The Cores 780 receive the messages via links 785 from the Network-on-chip 775, which received the messages via the Receiver-to-NOC adapter 750. The network architecture saves power using the mechanisms depicted in FIG. 7 by preferably activating the Receiver 740 only when packets are arriving that should be received. Furthermore, the network architecture preferably switches from Broadcast to Multicast when it becomes efficient, where the overhead of the List of recipients is small. It may switch to Unicast instead of Multicast if the expected number of recipients per List of recipients is close to 1. In another hybrid embodiment, the packets transmitted from the Receiver-to-NOC adapter 750 to the Network-on-chip 775 over link 770 are unicast in the case that there is one receiver, and flag-based multicast in the case that there are multiple receivers, thereby saving on the number of bits that must be transmitted with each packet.

FIG. 8 is a simplified schematic of an embodiment of an additional power saving mechanism that can be built into the network architecture. In this diagram, the Message Aggregator 610 sends its broadcast signals 810 over an Efficient Transmission Medium 800. In one preferred embodiment, the Efficient Transmission Medium 800 is a superconductor that must be supercooled. When a superconductor becomes supercooled, its resistance becomes zero, which greatly reduces the power required to send a signal over it (although the means of information transmission changes from high and low voltage since voltage loses its representation in the process of becoming a superconductor). It is unusual to use superconductors as a network link. However, the described architecture is particularly well suited to using superconductors because no routing is required within a superconducting supercooled Efficient Transmission Medium 800, since the network is a broadcast network.

Power is consumed when receivers 830 receive the broadcast signal 810 and output the Received Broadcast data 850 to the Processors 820. The power savings measures shown in FIG. 7, however, can be taken out of the Processor, such that the Activate signal 840 is transmitted from the Processor 820 to the Receiver 830, where the Receiver is held in the Efficient Transmission Medium 800 so that only those bits that are needed to be transmitted to Processors 820 by conventional means are in-fact transmitted outside the Efficient Transmission Medium 800. One means by which this may be implemented in the novel network architecture is by maintaining the Receiver 830 and Efficient Transmission Medium 800 in a supercooled environment, such as 4 Kelvin, which is sufficiently low heat as to be able to allow certain materials to become superconductors.

The physical restrictions that should be designed around in order to maintain the 4 Kelvin environment restrict how data can transmitted between room temperature and 4 Kelvin. In one embodiment, the information is transmitted as optical data through communication link that is also an insulator. The communication can therefore traverse the large temperature difference ruining the ability of the Efficient Transmission Medium 800 to be maintained at low temperature.

In another embodiment, the Efficient Transmission Medium 800 is preferably an optical fiber and the Receiver 830 preferably acts as an optical router to enable transmission of data at wide bandwidths at low power per gigabyte per second.

FIG. 9 is an exemplary process for the Bulk Synchronous programming paradigm for use with the described network architectures. In the Bulk Synchronous model, a large number of threads execute a section of code that can be executed independently. As soon as the independent threads arrive at instructions that depend on data that may have been altered by another thread, they wait, which is called bulk synchronization because all threads synchronize. At the synchronization point, the variables that have been written by threads and may be needed by other threads are preferably transmitted to those threads so that they will be ready when execution resumes. After the variables have been transmitted, execution resumes for the next section of code that can run independent of changes occurring in other threads. The synchronization process in the Bulk Synchronous paradigm can have a very high overhead since the transmission of the variables from all the threads that change them to all the threads that might need them can be very slow.

The advantage of the Bulk Synchronous paradigm is that it can be easier to program and that, outside of the synchronization process, the threads can execute in a massively parallel manner, which can lead to great power efficiency or very high overall performance. By reducing the penalty for synchronization through good network support, the advantages of the Bulk Synchronous programming paradigm can be more easily realized. One key advantage that the described network architecture has for the Bulk Synchronous paradigm is that the network overhead for sending a variable produced by one thread to another thread is the same or nearly the same as sending a variable produced by one thread to all other threads. In this way, programmers using the Bulk Synchronous programming paradigm with the novel network architecture gain a new advantage of being able to ignore how many threads require synchronization with a given variable, since the number of such threads does not decrease performance when the novel network architecture is used.

FIGS. 9 and 10 show how the novel network architecture may support the Bulk Synchronous paradigm. The process depicted in FIG. 9 preferably begins with the “Start (Bulk Synchronous program executed by each node)” step 900. This process is executed by each thread, or node, that is executing a Bulk Synchronous program.

The “Receive Relevant Context Variables from Broadcast Network” step 910 is proceeded-to via link 905 or via link 935. In this step, the Context Variables used by a given node are received by that node so that it can be ready to execute its next independent code section.

The “Run Next Independent Code Section” step 920 is proceeded-to via link 915. In this step, each node runs the next piece of code that does not depend on any variable updates that may have occurred by other threads since the most recent bulk synchronization (910). This step 920 preferably ends when a piece of code is to be executed that may definitely or possibly depend on a variable updated by another thread, at which the process proceeds to step 930 via link 925.

The “Send Relevant Context Variables to Message Aggregator” step 930 preferably begins the bulk synchronization step in which each of the independent threads send the variables that may be needed by other threads to the message aggregator. The Message aggregator 610 will preferably send these messages onto the broadcast network so that threads that know they may need the updates can receive those updates. Once all relevant context variables have been sent to the Message Aggregator 610, the process preferably proceeds back to step 910 via link 935.

FIG. 10 depicts the process performed by the Message Aggregator during execution of a Bulk Synchronous Program. The “Start (Bulk Synchronous program executed by Message Aggregator)” step 1000 preferably begins the process. The “Wait for context variables to finish arriving (or nearly finish)” step 1010 is preferably proceeded-to via link 1005 or via link 1025. At step 1010, preferably all of the context variables arrive at the Message Aggregator 610. In one embodiment, the Message Aggregator 610 knows how much time it will take to broadcast the data it has already received in the appropriate channels, and how long it will take for the remaining data to arrive, and can therefore begin the broadcast process early, prior to receiving all of the data that will be broadcast. This type of transmission is sometimes called “cut-through” and can reduce the penalty associated with the bulk synchronous paradigm. In another embodiment, those threads that take the longest amount of time to generate context variables are assigned TDM channels that occur later in time so that broadcast can begin prior to those context variables having been received by the Message Aggregator 610. After step 1010, the process preferably proceeds to step 1020 via link 1015.

The “Broadcast context variables and synchronization signal” step 1020 is proceeded-to via link 1015. In this step 1020, the context variables are broadcast over the novel network architecture to preferably all of the nodes running the bulk synchronous program. The process preferably continues iterative execution of the bulk synchronous program by returning to step 1010 via link 1025.

It will be appreciated by those skilled in the art that changes could be made to the embodiment(s) described above without departing from the broad inventive concept thereof. It is understood, therefore, that this invention is not limited to the particular embodiment(s) disclosed, but it is intended to cover modifications within the spirit and scope of the present invention as defined by the appended claims.

I claim:

1. A method for communication among processors in a distributed computing system, comprising:
receiving, at a first processor, via a first transmission medium, information regarding scheduling of a data transmission on a second transmission medium;
activating, in accordance with the information regarding scheduling of the data transmission on the second transmission medium, a receiver associated with the first processor and communicatively coupled to the second transmission medium; and
receiving, at the first processor, via the second transmission medium, the data associated with the information regarding the scheduling of a data transmission on a second transmission medium.

2. The method of claim 1 wherein the first processor is performing a first portion of a distributed computing task and wherein the data received in the scheduled data transmission comprises a processing result from a second processor performing a second portion of the distributed computing task.

3. The method of claim 1 wherein the data transmission on the second transmission medium uses at least one of dense wavelength division multiplexing and time division multiplexing.

4. The method of claim 3 wherein the receiver may be separately activated for reception of data on each of a plurality of wavelength bands.

5. The method of claim 1 further comprising:
deactivating the receiver associated with the first processor after receiving the data from the second transmission medium.

6. The method of claim 1 wherein activating the receiver is further responsive to a time-synchronization signal.

7. The method of claim 1 wherein the information regarding the scheduling of a data transmission on the second transmission medium comprises information regarding one or more channels of the second transmission medium on which the data transmission will be transmitted.

8. The method of claim 1 wherein information regarding scheduling of the data transmission on the second transmission medium is derived from a stored list of channels to receive, the stored list comprising at least one of absolute time data or relative time data regarding when data is to be received on those channels.

9. The method of claim 1 wherein information regarding scheduling of the data transmission on the second transmission medium comprises information regarding recipients for the data transmission.

10. The method of claim 9 wherein information regarding recipients for the data transmission comprises a set of binary values indicating whether each of a plurality of cores of the processor is a recipient of the scheduled data transmission.

11. The method of claim 1 wherein the first processor comprises the receiver, a plurality of cores, a receiver-to-network-on-a-chip adapter, and a memory.

12. The method of claim 1 wherein the data transmitted on the second transmission medium is transmitted by a message aggregator that receives data from a multi-tier system of network switches, which receive data transmissions from a plurality of processors comprising the first processor.

13. The method of claim 1 wherein receiving data associated with the information regarding the scheduling of a data transmission on a second transmission medium comprises receiving data on multiple channels.

14. The method of claim 1 wherein the receiver operates in a low-power mode and a high-power mode and activating the receiver comprises causing the receiver to change from the low-power mode to the high-power mode.

15. An apparatus comprising:
a plurality of processors;
a broadcast network medium; and
a plurality of network switches arranged in N tiers, wherein N is an integer greater than two;
wherein each of the plurality of processors is communicatively coupled to at least one of the plurality of switches in the first tier of the N tiers and communicatively coupled to the broadcast network medium; and
wherein each network switch of the lowest N−1 tiers is communicatively coupled to a network switch of the next higher tier.

16. The apparatus of claim 15 wherein each processor of the plurality of processors is configured to execute program code for:
receiving, at the processor, via a first transmission medium, information regarding scheduling of a data transmission on a second transmission medium;
activating, in accordance with the information regarding scheduling of the data transmission on the second transmission medium, a receiver associated with the processor and communicatively coupled to the second transmission medium; and
receiving, at the processor, via the second transmission medium, data associated with the information regarding the scheduling of a data transmission on a second transmission medium.

17. The apparatus of claim 15 wherein the plurality of network switches are arranged in a butterfly fat-tree topology.

18. A method of communication among processors in a distributed computing system comprising:
computing, at a first processor, a first result associated with a distributed computing task;
transmitting, from the first processor, the first result associated with the distributed computing task via a first transmission medium;
receiving, at a second processor, via a second transmission medium, information regarding scheduling of transmission of the first result associated with the distributed computing task;
activating, in accordance with the information regarding scheduling of the data transmission on the second transmission medium, a receiver associated with the first processor and communicatively coupled to the second transmission medium;
receiving, at the second processor, via a third transmission medium, first result associated with the distributed computing task; and
computing, at the second processor, using the first result associated with the distributed computing task, a second result associated with the distributed computing task.

19. The method of claim 18 wherein the third transmission medium is a broadcast transmission medium.

20. The method of claim 18 wherein the first network transmission medium is coupled to a first network switch, the second network transmission medium is coupled to a second network switch, and the first and second network switches are coupled to a third network switch.
